(19) United States
(12) Patent Application Publication
(10) Pub. No.: US 2011/0019308 A1
(43) Pub. Date: Jan. 27, 2011

(54) PERPENDICULAR MAGNETIC RECORDING MEDIUM, METHOD OF MANUFACTURING PERPENDICULAR MAGNETIC RECORDING MEDIUM, AND MAGNETIC RECORDING/REPRODUCING APPARATUS

(75) Inventor: Masato Fukushima, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku (JP)

(21) Appl. No.: 12/934,209

(22) PCT Filed: Mar. 27, 2009
(86) PCT No.: PCT/JP2009/056355

§ 371 Date: Sep. 23, 2010

(30) Foreign Application Priority Data
Mar. 28, 2008 (JP) 2008-088146

(51) Int. Cl. G11B 5/127; G11B 5/82; G11B 5/84

(52) U.S. Cl. 360/110; 360/135; 427/130; 216/22; G9B/5.04; G9B/5.293

(57) ABSTRACT

Disclosed is a perpendicular magnetic recording medium including: a nonmagnetic substrate; and a recording layer formed on the nonmagnetic substrate, the recording layer having magnetic anisotropy in a direction perpendicular to a surface of the nonmagnetic substrate and including a plurality of recording portions and a plurality of separation regions for isolating the neighboring recording portions, wherein the separation regions are formed of a material having a granular structure.

### TECHNICAL FIELD

The present invention relates to a perpendicular magnetic recording medium used in a hard disc device or the like, a method of manufacturing the perpendicular magnetic recording medium, and a magnetic recording/reproduction apparatus having the perpendicular magnetic recording medium.

The present invention contains subject matter of Japanese Patent Application No. 2008-88146 filed in the Japanese Patent Office on Mar. 28, 2008, the entire contents of which are incorporated herein by reference.

### BACKGROUND ART

Recently, the range of applications for magnetic recording apparatuses such as a magnetic disc apparatus, a Floppy (registered trademark) disc apparatus, and a magnetic tape apparatus has widened significantly, and the importance thereof has increased. Accordingly, the recording density of the magnetic recording medium used in such apparatuses has been improved remarkably. Particularly, as MR head (magnetoresistance head) and PRML (Partial Response Maximum Likelihood) techniques have been introduced, the surface recording density as the amount of information per unit area has drastically increased. Recently, as a GMR head (giant magnetoresistance head) and a TMR head (tunneling magnetoresistance head) have been introduced, the recording density has continued to increase by as fast as approximately 100% per year.

For such a magnetic recording medium, it is desirable to achieve higher surface recording densities in the future. For this reason, it is desirable for the magnetic recording layer to have a high magnetic coercive force, a high resolution, and a high signal-to-noise (SN) ratio. Recently, as the absolute film thickness of the medium has become thinner in order to achieve a high surface recording density, a phenomenon where the recording magnetization becomes weaker due to heat fluctuations has become problematic.

Particularly, the thermal stability of the recording is a significantly important technical issue. Particularly, since it is often the case that the thermal stability is degraded in order to improve the SN ratio, the tradeoff relationship between the SN ratio and the thermal safety has become a development goal in the future. Generally, in a medium having an excellent SN ratio, magnetic particles included in the magnetic layer have a fine crystal size. While the fine crystal size is effective at reducing noise in the medium, it tends to provide an unstable state from the viewpoint of the thermal stability of magnetization. Such a property is one of the reasons that improvement of the SN ratio causes the degradation of thermal stability.

Recently, an effort to improve the surface recording density by increasing track density as well as line recording density has been continuously made. A state-of-the-art magnetic recording apparatus has a track density of 110 kTPI. However, as the track density increases, a phenomenon is caused that interference between neighboring tracks occurs in the magnetic recording information due to the increased density. As a result, the magnetization transition area existing in the boundary area thereof is influenced so that it may act as a noise source, and the SN ratio is apt to be degraded. The aforementioned problem is directly linked to degradation of the bit error rate, and thus, it hinders the improvement of recording density.

In addition, as the track density increases, the distance between tracks is reduced. As a result, the magnetic recording apparatus demands a track servo technique of an extremely high precision. At the same time, in order to widely perform the recording and eliminate the influence from neighboring tracks as much as possible during the reproduction, a method of performing reproduction by reducing the track width in comparison with the time of the recording is generally used. However, while in this method the influence between tracks can be suppressed to the minimum, it is difficult to obtain sufficient reproduction output power. Therefore, it is difficult to obtain a sufficient SN ratio.

Recently, a perpendicular magnetic recording medium is employed in which magnetization recording is performed in the vertical direction against the film face of the thin film medium unlike the surface magnetic recording method in the conventional art in order to obtain a preferable SN ratio and a thermal stability in a medium having a high surface recording density.

Currently, the perpendicular magnetic recording medium generally includes, for example, a substrate, a soft magnetic underlayer (SUL), an intermediate layer, a perpendicular magnetic recording layer, and a protection film (if necessary) in this order and is used as a technique for obtaining a high recording density. However, even such a perpendicular magnetic recording medium demands a still higher recording density. In order to satisfy such demands, it is necessary to increase the track density even in the perpendicular magnetic recording medium. In order to increase the track density, it is necessary to reduce a write fringe on the edge of the recording portion of the perpendicular magnetic recording medium.

As one of the methods of addressing the problem in the fringe, a discrete track medium (DTM) can be exemplified (e.g., refer to Patent Documents 1 and 2).

Patent Document 1 discloses a disc-shaped medium having a convex portion functioning as a recording portion for recording data and a concave portion functioning as a guide band portion for distinguishing neighboring recording portions (the convex and concave portions may be understood as higher and lower portions, such as peak and valley portions).

Patent Document 2 proposes a magnetic disc including a recording track portion made of a magnetic member and a guide band portion interposed between the neighboring recording track portions, in which the guide band portion includes a separation region member formed of a nonmagnetic material. In Patent Document 2, examples of the separation region member includes oxides, nitrides, carbides, borides, or any one of a C-based, CH-based, or CF-based polymer compounds. Furthermore, Patent Document 2 discloses a technique of obtaining a disc where a recording magnetic member and a separation region member are alternately provided on the surface by performing sputtering until the guide band space is filled to cover the disc surface with an SiO₂ film and then grinding and planarizing the SiO₂ film until the surface of the recording magnetic member of the recording track portion is exposed.

In the disc-shaped medium disclosed in Patent Document 1, the recording portion is a convex portion, and the guide band is a concave portion, so that the unevenness exists on the disc surface. In the disc-shaped medium having unevenness on the disc surface, there is a problem that the unevenness on the surface affects the levitation characteristic of the recording/reproduction head.

Meanwhile, in the magnetic disc disclosed in Patent Document 2, there is no height difference between the recording magnetic member and the separation region member. Therefore, it is advantageous that the unevenness on the surface does not affect the levitation characteristics of the recording/reproduction head.

However, in the magnetic disc disclosed in Patent Document 2, a mutual diffusion of structural elements between the recording magnetic member and the separation region member may easily occur due to the manufacturing process. Therefore, the electromagnetic conversion characteristic of the magnetic disc degrades as time goes by.

In Patent Document 2, in order to manufacture the magnetic disc, after a film for forming the separation region member is provided on the surface, the film for forming the separation region member is etched and planarized through an ion beam etching or the like until the surface of the recording magnetic member is exposed. However, in this case, the surface of the separation region member interposed between the recording track portions after the etching becomes rough, and the smoothness of the surface becomes insufficient. In order to address such a problem, it can be envisaged that a protection film may be formed on the surface after the etching. However, since the surface of the separation region member after the etching is already rough, the smoothness of the surface may not become satisfactory even when the protection film is formed on the surface of the product after etching. Furthermore, even when metal is used in the separation region, unevenness is also generated on the surface formed through sputtering or the like, and planarization thereof is difficult.

The magnetic disc including the separation region member using a nonmagnetic material disclosed in Patent Document 2 has a disadvantage that the surface is vulnerable to scratching caused by a polishing process. For example, when the magnetic head is accidentally impacted after installation in the magnetic recording/reproduction apparatus, the surface is apt to be scratched. In order to address this problem, it can be envisaged that a protection film is formed on the surface of the magnetic disc. However, if the impact resistance of the protection film is insufficient even when the protection film is formed on the surface of the magnetic disc, the protection film may fail to resist the impact of the magnetic head on surface of the magnetic disc, and the surface defects may occur.

Patent Document 1: Japanese Unexamined Patent Application Publication No. 6-259709

Patent Document 2: Japanese Unexamined Patent Application Publication No. 9-97419

### DISCLOSURE OF INVENTION

### Problems to be Solved by the Invention

The present invention has been made to solve the aforementioned problems. The present invention provides a perpendicular magnetic recording medium and a manufacturing method thereof, by which a high recording density can be realized, excellent smoothness on the surface of the separation region can be achieved, a write fringe caused by the magnetic head is seldom generated when it is provided in the magnetic recording/reproduction apparatus, stable electromagnetic conversion characteristics can be achieved and maintained for a long time, and impact resistance regarding an impact caused by the magnetic head or the like is excellent.

In addition, the present invention provides a magnetic recording/reproduction apparatus including the perpendicular magnetic recording medium according to the present invention, by which a high recording density can be realized due to excellent smoothness on the surface of the separation region, a write fringe caused by the magnetic head is not generated, a stable electromagnetic conversion characteristic can be achieved for a long time, and impact resistance for an impact on the magnetic head or the like is excellent.

### Means to Solve the Problems

The inventors made a diligent effort to address the aforementioned problems and discovered that a material having a granular structure has a fine crystal structure, and thus, etching and/or polishing can be uniformly progressed in the case where the separation region is made of a material having a granular structure, and the film corresponding to the separation region is etched or polished. As a result, it is possible to resolve a problem relating to roughness on the surface of the separation region generated after the etching and/or polishing and obtain a surface of the separation region which is smooth and has excellent environment resistance. Furthermore, through a diligent effort, the inventors discovered that, in the case where a material having a granular structure is etched using a dry process, the surface can be smoothened as the etching progresses even when the initial surface has unevenness.

Moreover, through diligent effort, the inventors discovered that, if the recording portion is structured to include a magnetic layer formed of a magnetic material having a granular structure, the separation region is formed of a material having granular structure, and a composition of the material is approximated between the separation region and the magnetic layer as necessary, it is possible to prevent mutual diffusion of elements between the separation region and the magnetic layer and improve impact resistance against an impact caused by a magnetic head or the like.

A first aspect of the present invention relates to the following recording medium.

(1) A perpendicular magnetic recording medium including: a nonmagnetic substrate; and a recording layer formed on the nonmagnetic substrate, the recording layer having magnetic anisotropy in a direction perpendicular to a surface of the nonmagnetic substrate and including a plurality of recording portions and a plurality of separation regions for isolating the neighboring recording portions, wherein the separation regions are formed of a material having a granular structure.

The recording medium according to the first aspect of the present invention includes the following preferable embodiments.

(2) It is preferable that the material having a granular structure of the separation region described in the paragraph (1) is a nonmagnetic material.

(3) It is preferable that the recording portion of the perpendicular magnetic recording medium described in the paragraph (1) is a layered structure and includes a magnetic layer made of a magnetic material having a granular structure.

(4) It is preferable that the magnetic layer and the separation region of the perpendicular magnetic recording medium described in the paragraph (2) contain the same oxide.

(5) It is preferable that the magnetic layer and the separation region of the perpendicular magnetic recording medium described in the paragraph (2) or (3) contain Cr.

(6) It is preferable that the magnetic layer and the separation region of the perpendicular magnetic recording medium described in the paragraphs (2) to (5) contain an oxide within a range of 5 to 40% by volume.

(7) It is preferable that the magnetic layer and the separation region of the perpendicular magnetic recording medium described in the paragraphs (2) to (5) contain at least one selected from a group consisting of SiO₂, SiO, Cr₂O₃, CoO, Ta₂O₃, and TiO₂.

(8) In the perpendicular magnetic recording medium described in the paragraphs (2) to (7), it is preferable that the magnetic layer is arranged as an uppermost layer of the recording portion, and a protection film for covering the recording portion and the separation region is formed on the recording layer.

According to the second aspect of the present invention, there is provided a method of manufacturing the perpendicular magnetic recording medium described below.

(9) There is provided a method of manufacturing a perpendicular magnetic recording medium including a nonmagnetic substrate and a recording layer formed on the nonmagnetic substrate, the recording layer having magnetic anisotropy in a direction perpendicular to the surface of the nonmagnetic substrate and including a plurality of recording portions and a plurality of separation regions for isolating the neighboring recording portions, the method comprising: forming, on the nonmagnetic substrate, a recording layer having magnetic anisotropy in a direction perpendicular to the surface of the nonmagnetic substrate; forming a plurality of recording portions and a plurality of recesses for isolating the neighboring recording portions by removing an area corresponding to the separation regions from the recording layer to form the recesses; and filling the recess with a material having a granular structure to form the separation region.

The recording medium according to the second aspect of the present invention includes the following preferable embodiments.

(10) It is preferable that the material having the granular structure filled in the recesses described in the paragraph (9) is a nonmagnetic material.

(11) In the method of manufacturing the perpendicular magnetic recording medium described in the paragraph (9), it is preferable that the recording portion includes a magnetic layer formed of a magnetic material having a granular structure.

(12) In the method of manufacturing the perpendicular magnetic recording medium described in the paragraphs (9) to (11), it is preferable that the process of filling the recess includes; depositing a material having the granular structure on the recording layer having the recess to form a nonmagnetic layer having the recess filled with the material; and smoothening the surface of the nonmagnetic layer by removing a part of the surface of the nonmagnetic layer until the surface of the magnetic layer is exposed and a part of the surface of the magnetic layer is removed.

(13) It is preferable that the method of manufacturing the perpendicular magnetic recording medium described in the paragraph (12) further includes; forming, on the recording layer, a protection film for covering the recording portion and the separation region.

(14) In the method of manufacturing the perpendicular magnetic recording medium described in the paragraphs (9) to (13), it is preferable that the process of forming the recess includes; coating a resist on the recording layer to form a resist layer, removing an area of the resist layer corresponding to the separation region using a stamper, and removing an area of the recording layer where the resist layer is removed.

(15) In the method of manufacturing the perpendicular magnetic recording medium described in the paragraphs (9) to (14), it is preferable that, in the process of filling the recess, the recess is filled with a material having a granular structure using a sputtering method.

(16) In the method of manufacturing the perpendicular magnetic recording medium described in the paragraph (11), it is preferable that, in the process of smoothening, the surface of the nonmagnetic layer is smoothened using an ion beam etching method.

According to the third aspect of the present invention, there is provided a method of manufacturing the perpendicular magnetic recording medium described below.

(17) There is provided a magnetic recording/reproduction apparatus including a magnetic recording medium and a magnetic head for recording information on and reproducing information from the magnetic recording medium, wherein the magnetic recording medium is the perpendicular magnetic recording medium described in any one of the paragraphs (1) to (8).

### Effect of the Invention

It is possible to provide a perpendicular magnetic recording medium that has excellent smoothness on the surface of the separation region and is capable of realizing a high recording density. Furthermore, in the case where the perpendicular magnetic recording medium is provided in the magnetic recording/reproduction apparatus, there is no write fringe caused by a magnetic head, and it is possible to obtain a stable electromagnetic conversion characteristic for a long time and excellent impact resistance against an impact caused by the magnetic head or the like.

### BRIEF DESCRIPTION OF THE DRAWINGS

FIG. 1A shows a figure which explains an exemplary perpendicular magnetic recording medium according to the present invention and an exemplary method of manufacturing a perpendicular magnetic recording medium according to the present invention.

FIG. 1B shows a figure which explains an exemplary perpendicular magnetic recording medium according to the present invention and an exemplary method of manufacturing a perpendicular magnetic recording medium according to the present invention.

FIG. 1C shows a figure which explains an exemplary perpendicular magnetic recording medium according to the present invention and an exemplary method of manufacturing a perpendicular magnetic recording medium according to the present invention.

FIG. 1D shows a figure which explains an example of a perpendicular magnetic recording medium according to the present invention and a method of manufacturing a perpendicular magnetic recording medium according to the present invention.

FIG. 1E shows a figure which explains an example of a perpendicular magnetic recording medium according to the present invention and a method of manufacturing a perpendicular magnetic recording medium according to the present invention.

FIG. 1F shows a figure which explains an example of a perpendicular magnetic recording medium according to the present invention and a method of manufacturing a perpendicular magnetic recording medium according to the present invention.

FIG. 1G shows a figure which explains an example of a perpendicular magnetic recording medium according to the present invention and a method of manufacturing a perpendicular magnetic recording medium according to the present invention.

FIG. 1H shows a figure which explains an example of a perpendicular magnetic recording medium according to the present invention and a method of manufacturing a perpendicular magnetic recording medium according to the present invention.

FIG. 1I shows a figure which explains an example of a perpendicular magnetic recording medium according to the present invention and a method of manufacturing a perpendicular magnetic recording medium according to the present invention.

FIG. 2 shows a figure which explains a perspective view illustrating an example of a hard disc apparatus as a magnetic recording/reproduction apparatus according to the present invention.

### DESCRIPTION OF THE REFERENCE SYMBOLS

A: perpendicular magnetic recording medium,

1: nonmagnetic substrate

2: soft under layer

3: orientation control layer

4: magnetic layer

6: recording layer

7: resist layer

8: medium

9: stamper

9a: concave portion

10: unevenness portion

11b: recess

12: nonmagnetic layer

14: separation region

15: recording portion

16: protection film

17: lubricant layer

### BEST MODE FOR CARRYING OUT THE INVENTION

Hereinafter, the present invention will be described with reference to the accompanying drawings, but the present invention is not limited thereto. Any addition, omission, substitution, or other modifications may be possible without departing from the scope of the invention. The present invention is also not limited by the descriptions, and is only limited by the appended claims.

Hereinafter, advantages of the present invention will be described.

The perpendicular magnetic recording medium according to the present invention is a perpendicular magnetic recording medium having a recording layer, which has magnetic anisotropy in a direction perpendicular to a surface of the nonmagnetic substrate, and the recording layer has a plurality of recording portions and an separation region for isolating the neighboring recording portions, and the separation region is made of a granular structure material, and preferably, a nonmagnetic material. Therefore, it is possible to readily obtain an separation region which is smooth and has excellent environment resistance. More specifically, since the material of the granular structure has a fine crystal structure, when a film which forms the separation region is etched and/or polished in order to obtain the separation region made of the granular structure material, the film which forms the separation region is uniformly etched and/or polished. As a result, it is possible to address the roughness of the surface of the separation region occurring after etching and/or polishing and obtain the separation region having a surface which is smooth and has excellent environment resistance.

In addition, in the perpendicular magnetic recording medium according to the present invention, since the recording layer which has magnetic anisotropy in the perpendicular direction against the surface of the nonmagnetic substrate is formed on the nonmagnetic substrate, and the recording layer includes a plurality of recording portions and an separation region for isolating the neighboring recording portions, it is possible to realize a high recording density. Furthermore, in the case where the perpendicular magnetic recording medium is provided in the magnetic recording/reproduction apparatus, it is advantageous that the write fringe caused by the magnetic head is small. It is also possible to increase the track density.

In the perpendicular magnetic recording medium according to the present invention, it is preferable that the recording portion includes a magnetic layer made of a magnetic material having a granular structure, and the separation region is made of a nonmagnetic material having a granular structure. In this case, the composition of the material of the separation region and the composition of the material of the magnetic layer may be approximated to each other. As a result, it is possible to prevent mutual diffusion of the structural elements between the separation region and the magnetic layer. Therefore, in the case where such a perpendicular magnetic recording medium is provided in the magnetic recording/reproduction apparatus, it is possible to obtain a stable electromagnetic conversion characteristic for a long time.

Since the composition of the material can be approximated between the separation region and the magnetic layer, it is possible to approximate the hardness and density thereof between the separation region and the magnetic layer. If both a soft portion and a hard portion exist, generally, the soft portion functions as the origin for cracks. However, according to the present invention, the hardness difference or density difference within the recording portion is small, and therefore the aforementioned origin for the cracks is not generated. As a result, it is possible to obtain excellent impact resistance to the impact caused by the magnetic head or the like. In addition, in the case where the perpendicular magnetic recording medium having the magnetic layer arranged on the uppermost layer of the recording portion is provided with the protection film covering the recording portion and the separation region, the hardness and density of the recording portion and the separation region, which support the protection film as a under layer, are similar to each other. Therefore, since the origin of the cracks is hardly formed as described above, the protection film is hardly damaged, and it is possible to obtain more excellent impact resistance.

In the perpendicular magnetic recording medium according to the present invention, it is preferable that the recording portion includes a magnetic layer made of a magnetic material having a granular structure, and the separation region is made of a nonmagnetic material having a granular structure. In this case, it is preferable that the composition of materials of the separation region and the composition of materials of the magnetic layer are approximated each other. As a result, an etching rate and a polishing rate can be approximated between the separation region and the magnetic layer. Through the approximation, in the case where the separation region and the magnetic layer are simultaneously etched or polished in order to manufacture the perpendicular magnetic recording medium having the magnetic layer arranged on the uppermost layer of the recording portion, a height difference is hardly generated in the interface between separation region and the magnetic layer. Therefore, since a continuous smooth surface can be made on the separation region and the magnetic layer, it is possible to readily obtain a recording layer having excellent smoothness on the surface. If the recording layer of the perpendicular magnetic recording medium has an excellent surface smoothness, it is possible to reduce the levitation amount of the magnetic head in the case where the perpendicular magnetic recording medium is provided in the magnetic recording/reproduction apparatus.

Through a method of manufacturing the perpendicular magnetic recording medium according to the present invention, it is possible to manufacture the perpendicular magnetic recording medium according to the present invention.

In addition, since the magnetic recording/reproduction apparatus according to the present invention includes the perpendicular magnetic recording medium according to the present invention, it is possible to obtain excellent surface smoothness on the separation region, realize a high recording density, eliminate the write fringe caused by the magnetic head, obtain a stable electromagnetic conversion characteristic for a long time, and obtain excellent impact resistance against the impact of the magnetic head or the like.

Next, the perpendicular magnetic recording medium, a method of manufacturing the perpendicular magnetic recording medium, and the magnetic recording/reproduction apparatus will be described in detail with reference to the accompanying drawings.

Magnetic Recording Medium

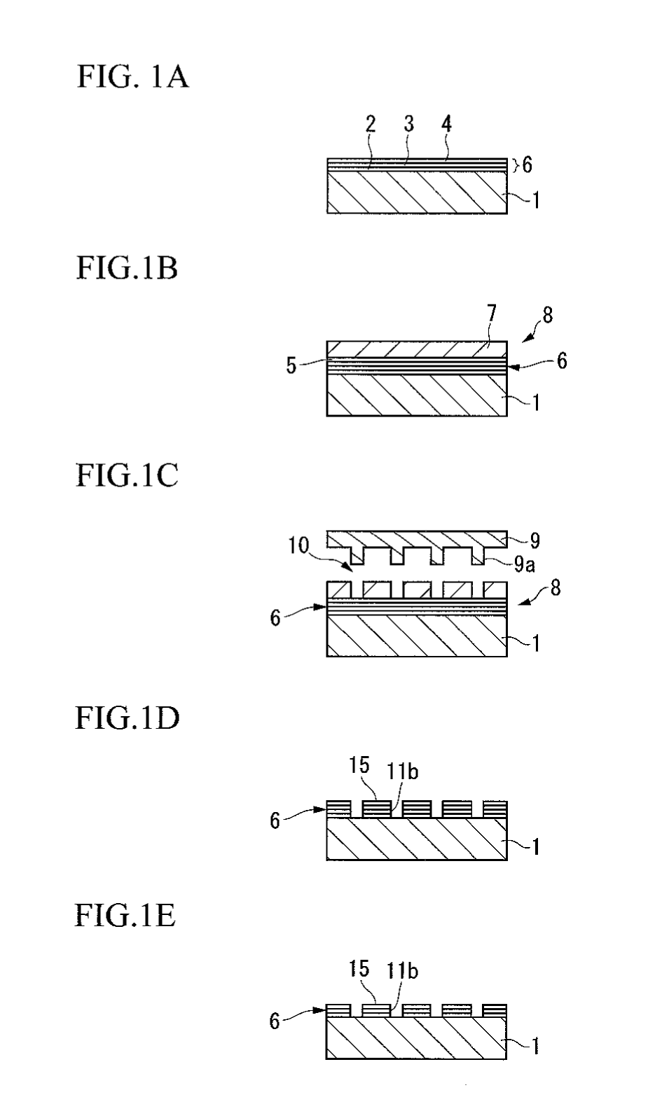

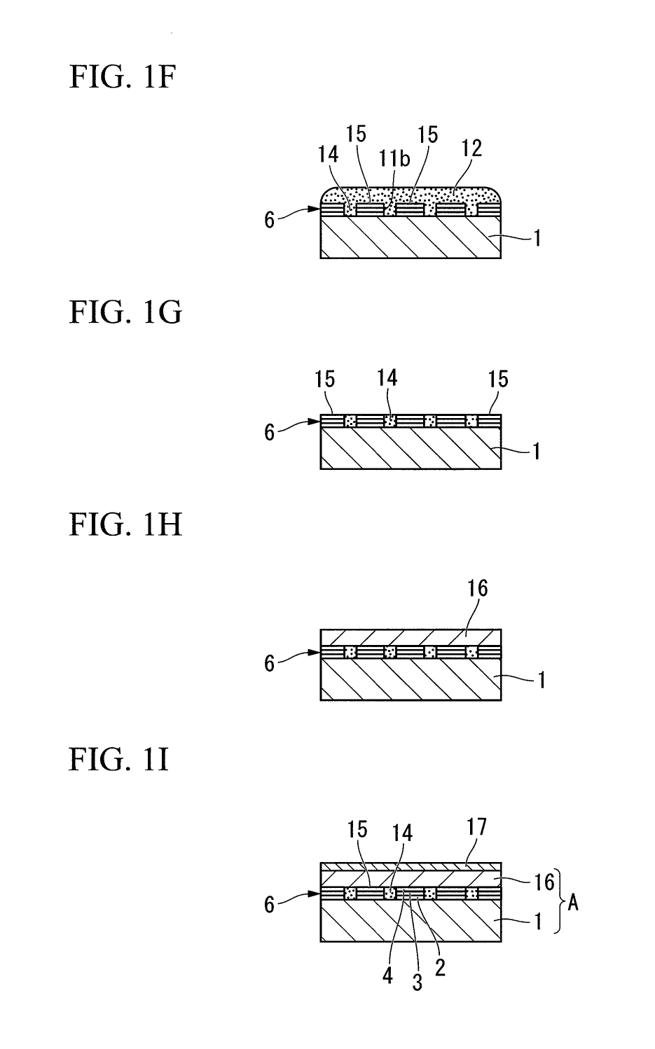

FIGS. 1A to 1I illustrate an example of a perpendicular magnetic recording medium and an example of a method of manufacturing the perpendicular magnetic recording medium according to the present invention. FIG. 1I is an enlarged cross-sectional view illustrating the perpendicular magnetic recording medium according to the present invention. In FIG. 1I, only a part of the disc-shaped perpendicular magnetic recording medium is enlargedly illustrated.

The perpendicular magnetic recording medium A shown in FIG. 1I includes a nonmagnetic substrate 1, a recording layer 6 formed on the nonmagnetic substrate 1, a protection film 16 formed on the recording layer 6, and a lubricant layer 17 formed on the protection film 16.

The recording layer 6 has magnetic anisotropy in a direction perpendicular against the surface of the nonmagnetic substrate 1 and, as shown in FIG. 1I, includes a plurality of recording portions 15 for magnetic recording and an separation region 14 for isolating the neighboring recording portions 15. The recording portion 15 is a recording track portion or bit portion formed with a predetermined width in a concentric circle shape, and is formed such that a soft under layer 2, an orientation control layer 3, and a magnetic layer 4 are sequentially laminated as shown in FIG. 1I.

According to the present embodiment, a magnetic layer 4 is arranged as an uppermost layer of the recording portion 15. Therefore, the upper surface of the recording layer 6 includes a surface portion of the magnetic layer 4 and a surface portion of the separation region 14. The upper surface of the recording portion 15 (the upper surface of the magnetic layer 4) and the upper surface of the separation region 14 are covered by the protection film 16.

As shown in FIG. 1I, there is no height difference in the interface between the magnetic layer 4 and the separation region 14, and the surface of the recording layer 6 is a continuous smooth plane which is structured by the surface of the magnetic layer 4 and the surface of the separation region 14. The surface roughness Ra of the recording layer 6 is preferably small, and specifically, equal to or smaller than 1 nm, more preferably, equal to or smaller than 0.5 nm, and yet more preferably, equal to or smaller than 0.3 nm. As the surface roughness of the recording layer 6 is reduced, the surface roughness of the protection film 16 and the lubricant layer 17 formed on the recording layer 6 can be reduced, and it is possible to obtain the perpendicular magnetic recording medium A having an excellent surface smoothness. When the perpendicular magnetic recording medium A having an excellent surface smoothness is provided in the magnetic recording/reproduction apparatus, it is possible to reduce the levitation amount of the magnetic head and realize the magnetic recording having a yet higher density.

The nonmagnetic substrate 1 may be selected as necessary. The substrate may be optionally selected from substrates in so far as the substrates are nonmagnetic substrate. For example, examples thereof include Al alloy substrate which contains Al as a main component such as Al—Mg alloy, and a substrate made of crystallized glass, amorphous glass, silicon, titan, ceramics, carbon, and various kinds of resin. As the substrate made of crystallized glass, a lithium-based crystallized substrate may be used. As the substrate made of amorphous glass, a soda-lime glass or aluminosilicate glass substrate may be used.

The average surface roughness Ra of the nonmagnetic substrate 1 is preferably small. Specifically, the average surface roughness Ra is equal to or smaller than 1 nm and preferably equal to or smaller than 0.5 nm because it provides an excellent perpendicular orientation of the magnetic layer 4 and, as described below, it allows pressure distribution to be reduced when the stamper is pressed with a high pressure so as to improve fabrication uniformity. It is preferable that the surface undulation Wa of the nonmagnetic substrate 1 is equal to or smaller than 0.3 nm, and more preferably equal to or smaller than 0.2 nm because it allows the pressure distribution when the stamper is pressed with a high pressure to be reduced, and the fabrication uniformity is improved. The thickness of the substrate can be selected as necessary.

The soft under layer 2 is formed of a soft magnetic material. Specifically, although it may be selected as necessary, examples of a material of the soft under layer 2 include a material containing at least one of Fe, Co, and Ni. Examples of a material containing Fe, Co, and/or Ni used in the soft under layer 2 include a FeCo alloy (such as FeCoB, FeCoSiB, FeCoZr, and FeCoZrB), a FeTa alloy (such as FeTaN and FeTaC), and Co alloy (such as CoTaZr, CoZrNb, and CoB).

While the soft under layer 2 may be a single layer, it may preferably have a laminated structure. While it may be designed as necessary, for example, it may be obtained by providing a layer made of any one of Ru, Re, or Cu with a predetermined thickness between two soft magnetic films so that upper and lower soft magnetic films can be combined in an antiferromagnetic manner. If the soft under layer 2 has such a layered structure, it is possible to improve a WATE (Wide Area Track Erasure) phenomenon which is a characteristic problem of perpendicular magnetic recording mediums. While the thickness of the soft under layer 2 can be selected as necessary, it is preferably set to 10 to 200 nm, and more preferably, 20 to 100 nm.

The orientation control film 3 is provided to control the crystal orientation and the crystal size of the magnetic layer 4 as the under layer of the magnetic layer 4. While the material used in the orientation control film 3 may be selected as necessary, an element having an hcp structure or fcc structure is preferably used, and Ru is particularly preferable. In addition, the thickness of the orientation control film 3 is preferably equal to or smaller than 30 nm. If the thickness of the orientation control film 3 is larger than 30 nm, in the case where perpendicular magnetic recording medium A is installed in the magnetic recording/reproduction apparatus as shown in FIG. 1I, the distance between the magnetic head and the soft under layer 2 during the recording/reproduction increases, and an OW (over-write) characteristic or a resolution of the reproduction signal is degraded, so that it is not preferable. While the thickness of the orientation control film 3 can be selected as necessary, it is preferably set to 1 to 100 nm, and more preferably set to 10 to 50 nm.

The magnetic layer 4 is preferably made of a magnetic material having a granular structure. The magnetic material having a granular structure means a structure in which a plurality of magnetic material particles are distributed in the oxide as a matrix. That is, the oxide covers the circumferences of a plurality of magnetic material particles. In addition, while the magnetic material particles may have a columnar shape, it may have a circular shape or other shapes which are different from the columnar shape. The magnetic material particle may be larger than the film thickness of the magnetic layer 4. For example, the magnetic material particle may have a columnar shape passing through the magnetic layer 4 and having a film thickness larger than that of the magnetic layer 4. The magnetic material particle may be formed of a material selected as necessary. As a preferable example, it may be made of a material containing Co, Cr, and/or Pe. The shape or size of the magnetic material particle may be selected as necessary. A preferable shape is a columnar shape. A preferable size includes a length of 1 to 50 nm and a width of 1 to 10 nm. The magnetic layer 4 preferably includes magnetic material particles within a range of 99 to 70 at %, and more preferably within a range of 95 to 85 at %. The magnetic material having a granular structure according to the present invention may be made of a material in which the circumference of the nonmagnetic material particle is perfectly covered by the oxides, or only a part thereof may be covered by the oxides. For example, the magnetic material may include a columnar crystal passing through the oxide layer in the upper and lower faces, and only the side face of the magnetic material particle may be covered by oxides.

While the magnetic material having a granular structure of the magnetic layer 4 may be selected as necessary, and particularly, a magnetic material containing at least Co, Pt, and an oxide is preferably used. While the amount of Co may be selected as necessary, it is preferably set to 50 to 80 atom % for all of the magnetic material particles. The amount of Pt is preferably set to 10 to 20 atom % for all of the magnetic material particles. In addition, elements such as Cr, B, Cu, Ta, and Zr may be added as necessary to the magnetic material in order to improve the SNR characteristic (the SN ratio). While the amounts of those elements may be selected as necessary, they are preferably set to 5 to 25 atom % for all of the magnetic material particles.

The oxides contained in the magnetic material having a granular structure of the magnetic layer 4 may be selected as necessary. For example, one or more kinds of SiO₂, SiO, Cr₂O₃, CoO, Ta₂O₃, or TiO₂ may be used.

In addition, the magnetic layer 4 preferably contains oxides within a range of 15 to 40 volume %, and more preferably within a range of 15 to 25 volume %. If the volume of the oxides is smaller than 15 volume %, it is not preferable because the SNR characteristic may be insufficient. If the volume of the oxide is larger than 40 volume %, it is not preferable because a magnetic coercive force corresponding to a high recording density may not be achieved.

The nucleation magnetic field (−Hn) of the magnetic layer 4 is preferably equal to or higher than 1.5 (kOe). If −Hn is lower than 1.5 (kOe), it is not preferable because heat fluctuation may occur.

The thickness of the magnetic layer 4 is preferably set to 6 to 18 nm. If the thickness of the magnetic layer 4 is set to be within the aforementioned range, it is preferably possible to obtain a sufficient output power without degrading the OW characteristics.

The separation region 14 is preferably made of a granular structure material. The granular structure material may be referred to as a nonmagnetic material having a granular structure. According to the present invention, the “nonmagnetic material” or the “nonmagnetic material particle” is not necessary to be perfectly nonmagnetic from the viewpoint of magnetism. In other words, the “nonmagnetic material” or the “nonmagnetic material particle” refers to a material having a reduced magnetic force sufficient to isolate the magnetic recording portion and perform magnetic recording and reproducing regarding the magnetic recording portion. In other words, the nonmagnetic material refers to a material having a lower magnetic force than that of the magnetic material of the magnetic recording portion. A material of the granular structure used in the separation region means a structure obtained by diffusing a plurality of material particles, i.e., nonmagnetic material particles within the oxide as a matrix. In other words, it has a structure in which the circumferences of a plurality of nonmagnetic material particles are filled by oxides. While the nonmagnetic material particles may have a spherical shape, other shapes such as a columnar shape, which is different from the spherical shape, may be used as well. The size of the nonmagnetic material particle may be larger than the film thickness of the separation region 14, and the nonmagnetic material particle may have a columnar shape larger than the thickness of the magnetic layer 4 and is passing through the separation region 14. While the nonmagnetic material particle may be formed of a material selected as necessary, preferable examples thereof include materials which contain Co, Cr, and/or Pe. While the size or the shape of the nonmagnetic material particle may be selected as necessary, it preferably has a length of 1 to 50 nm and a width of 1 to 10 nm. The separation region 14 preferably contains the material particles within a range of 99 to 70 at %, and more preferably within a range of 95 to 85 at %. The oxides contained in the nonmagnetic material having a granular structure may be selected as necessary.

The nonmagnetic material having a granular structure according to the present invention may be a material in which the circumference of the nonmagnetic material particle is perfectly covered by the oxides, or only a part thereof may be covered by the oxides. For example, only the side face of the nonmagnetic material particle may be covered by the oxides.

A material having a granular structure of the separation region 14 preferably includes a nonmagnetic material having a granular structure containing at least Cr. Since dry etching can be readily applied to the material having a granular structure containing Cr, it is possible to readily obtain an separation region 14 having a smooth surface with excellent environment resistance. While the ratio of Cr can be selected as necessary, it is preferably set to 25 to 50 atom % for the nonmagnetic particles. It may contain a magnetic element if the amount thereof is not large.

As the oxides contained in the nonmagnetic material having a granular structure, one or more kinds of SiO₂, SiO, Cr₂O₃, CoO, Ta₂O₃, and TiO₂ can be cited. It is preferable for the nonmagnetic material having a granular structure to contain such oxides, since it is easier to perform dry etching.

The separation region 14 preferably contains oxides within a range of 15 to 40 volume %, and more preferably within a range of 20 to 30 volume %. If the volume percentage of the oxides contained in the separation region 14 is set to the aforementioned range, the dry etching can be readily performed to form the separation region 14, and it is possible to level the roughness of the surface of the separation region 14 obtained through the dry etching.

Additional Approximation Between Materials of Magnetic Layer 4 and Separation Region 14

According to the present embodiment, in order to further approximate a material of the magnetic layer 4 and a material of the separation region 14, the materials which are included in the magnetic layer 4 and the separation region 14 preferably have at least one of the following configurations (1) to (5).

(1) The same oxide is used in both the material of the magnetic layer 4 and the material of the separation region 14. If the same oxide is used, it is possible to prevent a phenomenon that the covalent bonding strength between oxygen and an element of the oxide in the magnetic layer 4 is different from such covalent bonding strength in the separation region 14 due to a difference of the oxide contained therein. As a result, mutual diffusion of the oxygen element that may occur when the covalent bonding strength between oxygen and the element of the oxide is different between the magnetic layer 4 and the separation region 14 hardly occurs (i.e., migration of oxygen atoms from the oxide of the recording track portion 15 to the separation region 14, or migration of oxygen atoms from the oxide of the separation region 14 to the recording track portion 15 hardly occurs). For example, in the magnetic recording/reproduction apparatus including the perpendicular magnetic recording medium A shown in FIG. 1I, if oxygen atoms migrate between the magnetic layer 4 and the separation region 14 due to a difference in the oxide contained therein, problems may be caused such that characteristics such as the SNR characteristic and the magnetic coercive force is changed after the magnetic layer 4 and the separation region 14 are stored in a high temperature for a long time. However, it is possible to address the aforementioned problem if the same oxide is used in both the magnetic layer 4 and the separation region 14.

(2) Cr is contained as one of materials of the magnetic layer 4, and one of materials of the separation region 14. If Cr is contained therein, in the case where the magnetic recording/reproduction apparatus includes the perpendicular magnetic recording medium A as shown in FIG. 1I, it is possible to improve the SNR characteristic and make it easier to apply the dry etching to the magnetic layer 4 and the separation region 14. As a result, in the case where the dry etching is simultaneously applied to the separation region 14 and the magnetic layer 4, it is possible to readily obtain the recording layer 6 having an excellent surface smoothness.

(3) A material of the magnetic layer 4 and a material of the separation region 14 contain an oxide within a range of 5 to 40 volume %, and preferably within a range of 10 to 20 volume %. While it is preferable that the amount of the oxide is the same or similar to each other, it may differ within this range. If the oxide is contained therein within the aforementioned range, it is possible to further approximate the etching rate and the polishing rate between the separation region 14 and the magnetic layer 4. Therefore, in the case where the separation region 14 and the magnetic layer 4 are simultaneously etched and/or polished, a height difference does not occur in the interface between the separation region 14 and the magnetic layer 4, and it is possible to readily provide a continuous smooth plane on both the separation region 14 and the magnetic layer 4.

(4) The oxides of the materials which forms the magnetic layer 4 and the separation region 14 contain one or more kinds of SiO₂, SiO, Cr₂O₃, CoO, Ta₂O₃, and TiO₂. While it is preferable that the magnetic layer and the separation region contain the same compound, they may contain different compounds. As a result, the magnetic layer 4 has a granular structure, and it is possible to isolate and miniaturize the magnetic particles and improve the magnetic characteristic of the magnetic layer 4. In addition, it is possible to further improve the etching characteristic of the nonmagnetic material contained in the separation region 14 and obtain a smooth etching surface.

(5) According to the present embodiment, in order to approximate the materials of the magnetic layer 4 and the separation region 14, Co, Pt or the like may be further added to the magnetic layer 4 and the separation region 14. While it is preferable that the same material is added, the added material may differ. Through the addition, it is possible to obtain the magnetic layer having a granular structure which is excellent in noise characteristic. Since compositions of the separation region 14 and the magnetic layer 4 are similar to each other, it is possible to obtain the same etching characteristics for both the separation region 14 and the magnetic layer 4.

In the case where Co, Pt or the like is added to the separation region 14 and the magnetic layer 4, the nonmagnetic particle of the separation region 14 preferably includes a Cr alloy containing Co as a first main component.

The protection film 16 may be selected as necessary. A protection film used in a general magnetic recording medium may be appropriately used. For example, a DLC (Diamond Like Carbon) thin film is used. In addition, as the protection layer 16, a carbonized layer such as C, hydronized C, nitrized C, amorphous C, and SiC, or a thin film made of SiO₂, Zr₂O₃, TiN, or the like may be used in addition to the DLC thin film. In addition, the protection layer 16 may include two or more thin film layers.

The thickness of the protection layer 16 is preferably set to 1 to 10 nm, and more preferably set to 1 to 5 nm. In addition, the thickness of the protection layer 16 is preferably set as thin as possible if it guarantees sufficient durability.

The lubricant layer 17 may be selected as necessary. Examples thereof include layers formed of a material selected from a fluorine containing lubricant, a hydrocarbon based lubricant, or a mixture thereof. While the thickness of the lubricant layer 17 may be selected as necessary, it is typically set to 1 to 4 nm.

Method of Manufacturing Perpendicular Magnetic Recording Medium

Next, as an example of the method of manufacturing the perpendicular magnetic recording medium according to the present invention, a method of manufacturing the perpendicular magnetic recording medium A shown in FIG. 1I will be described with reference to FIGS. 1A to 1H.

FIG. 1A is an enlarged cross-sectional view illustrating a state that the recording layer is formed on the nonmagnetic substrate. FIG. 1B is an enlarged cross-sectional view illustrating a state that the resist layer is formed on the recording layer. FIG. 1C is an enlarged cross-sectional view illustrating a state that a portion of the resist layer corresponding to an area, to which the separation region is formed, is removed. FIG. 1D is an enlarged cross-sectional view illustrating a state that the entire resist layer is removed, and a plurality of recesses for isolating the recording portion into a plurality of sections are formed on the recording portion (recording layer). FIG. 1F is an enlarged cross-sectional view illustrating a state that a layer of the nonmagnetic material having a granular structure is deposited on the recording portion where the recesses are formed. FIG. 1G is an enlarged cross-sectional view illustrating a state that the surface of the layer of the nonmagnetic material is removed, and the surface of the recording layer is smoothened. FIG. 1H is an enlarged cross-sectional view illustrating a state that the protection layer is formed on the surface of the smoothened recording layer.

In order to manufacture the perpendicular magnetic recording medium A shown in FIG. 1I, first, a recording layer 6 as a layered structure is formed by sequentially forming a soft under layer 2, an orientation control layer 3, and a magnetic layer 4 on the disc-shaped nonmagnetic substrate 1 as shown in FIG. 1A (a process of forming the recording layer).

Next, a mask layer 5, for example, made of carbon is provided on the recording layer 6 using a sputtering method, a CVD method or the like as shown in FIG. 1B. The mask layer 5 is provided as necessary to more reliably mask a portion of the recording layer 6 corresponding to the recording portion 15 when a portion of the recording layer 6 corresponding to the separation region 14 is removed.

Then, the resist is coated on the recording layer 6 where the mask layer 5 is provided, and a medium 8 having the resist layer 7 is formed as shown in FIG. 1B. The resist used to form the resist layer 7 may be selected as necessary, and a photoresist used in an industrial field may be widely used. In general, the resist layer 7 may be formed by thinly and uniformly coating the resist using a spin coat or the like, baking it using an oven at a predetermined temperature for a predetermined time so that an unnecessary organic solvent or the like is removed. The method of forming the resist layer 7 may be appropriately adjusted depending on the characteristics of the resist that is used.

Subsequently, a portion of the resist layer 7 corresponding to an area, to which the separation region 14 is formed, is removed by making the stamper 9 abut on the surface of the medium 8 and pressing it with a high pressure, and an unevenness portion 10 having a desired shape, for example, a desired track shape or a bit shape is formed on the surface of the medium 8 as shown in FIG. 1C.

The stamper 9 may be selected as necessary. For example, a stamper may be used which have a disc shape matching with the disc shape of the nonmagnetic substrate 1, and have a surface where a concave portion 9a corresponding to the surface shape of the recording portion 15 of the perpendicular magnetic recording medium A shown in FIG. 1I is formed. The stamper 9 may be obtained by forming the shape of a fine concave portion 9a on a metal plate, for example, using an electron beam patterning method or the like. The material of the stamper 9 is not particularly limited and may include a material having a sufficient hardness and durability, such as, for example, a metal such as Ni.

Then, a plurality of recesses 11b for isolating a recording portion 15 from neighboring a plurality of recording portions 15 including the magnetic layer 4 are formed by removing the recording layer 6 and the mask layer 5 corresponding to the area where the resist layer 7 is removed (the area corresponding to the separation region 14) using an ion beam etching (IBE) method or an ion milling method. As shown in FIG. 1D, the resist layer 7 remaining on the recording portion 15 is removed (a process of forming the recess). The shape, the positions, and the sizes of the recording portion 15 and the recess 11b are selected as necessary. In addition, in the recording layer 6 obtained in this process, the recording portions 15 and the recesses 11b located between the recording portions 15 are provided alternately in a radial direction.

Then, as shown in FIG. 1E, the mask layer 5 remaining on the recording portion 15 is removed through an oxygen plasma etching, an ion milling or the like.

Subsequently, the nonmagnetic layer 12 is formed by laminating the nonmagnetic material having a granular structure on the recording layer 6 where the recesses 11b are provided as shown in FIG. 1F (a process of forming the nonmagnetic layer). As a result, the nonmagnetic material having a granular structure is filled in at least the recess 11b to form the separation region 14 (a process of filling the recess). It is preferable to use a sputtering method to fill the nonmagnetic material having a granular structure in the recess 11b. By appropriately adjusting conditions such as a deposit rate or a gas pressure using the sputtering method, it is possible to readily fill the nonmagnetic material having a granular structure from the bottom of the recess 11b which is significantly fine and deep.

In addition, if there is a portion where the nonmagnetic material having a granular structure is not filled in the recess 11b, a magnetic interaction between the recording portions 15 is not sufficiently blocked, and it may not be possible to obtain a sufficient recording/reproducing characteristic. Furthermore, when a portion where the nonmagnetic material having a granular structure is not filed in the recess 11b makes contact with gases such as oxygen in the air, corrosion resistance of the perpendicular magnetic recording medium A may be degraded.

Next, as shown in FIG. 1G, in order to smoothen the surface of the nonmagnetic layer 12 that has been formed, a part of the magnetic layer 4 and a part of the nonmagnetic layer 12 are simultaneously removed to expose the magnetic layer 4 (a smoothening process). As a result, each of the recording portions 15 is partitioned by the separation region 14 and exposed. Since the nonmagnetic layer 12 is made of a nonmagnetic material having a granular structure, even in the case where an initial surface of the nonmagnetic layer 12 before the smoothening is uneven and irregular, the unevenness can be alleviated, and the surface can be smoothened as the smoothening progresses through the polishing or etching.

When the surface after the nonmagnetic layer 12 is formed is smoothened, the thickness of the magnetic layer 4 to be removed together with the nonmagnetic layer 12 is not particularly limited. For example, in order to achieve a sufficient smoothening effect by simultaneously removing the nonmagnetic layer 12 and the magnetic layer 4, it is preferable that a thickness of the magnetic layer 4 to be removed is equal to or larger than 1 nm.

In the smoothening process, any method may be employed if it can be used to smoothly process the surface of the recording layer 6 including the recording portion 15 and the separation region 14 so that it can be used in the perpendicular magnetic recording medium A without degrading the performance of the perpendicular magnetic recording medium A. For example, while polishing according to a CMP (Chemical Mechanical Polish) method or dry etching such as an ion beam etching method may be used, the ion beam etching technique is preferably used. In the case where the surface of the recording layer 6 is smoothened using the ion beam etching method, it is possible to reduce contamination of the etching surface.

Then, as shown in FIG. 1H, a DLC film, which is a protection film 16 for covering the recording portion 15 and the separation region 14 that have been smoothened, is formed using a film formation method such as a plasma CVD method.

Then, the perpendicular magnetic recording medium A shown in FIG. 1I is obtained by forming another lubricant layer 17 on the protection film 16.

In the perpendicular magnetic recording medium A according to the present embodiment, the recording layer 6 having magnetic anisotropy in a direction perpendicular to the surface of the nonmagnetic substrate 1 is formed on the nonmagnetic substrate 1, and the recording layer 6 includes a plurality of recording portions 15 and the separation region 14 for isolating neighboring recording portions 15. The recording portion 15 preferably includes the magnetic layer 4 formed of a magnetic material having a granular structure, and the separation region 14 is made of a nonmagnetic material having a granular structure, so that the following advantages (A) to (D) can be obtained.

(A) Since the separation region 14 is made of a nonmagnetic material having a granular structure, the separation region 14 has a fine crystal structure. Since the crystal structure is fine, the etching progresses uniformly. As a result, it is possible to uniformly progress etching and/or polishing of the nonmagnetic layer 12 in the case where the nonmagnetic layer 12 is etched and/or polished to obtain the separation region 14. After the etching and/or polishing, it is possible to obtain an separation region 14 having a surface which is smooth and has excellent environment resistance.

(B) Since the separation region 14 and the magnetic layer 4 have similar material composition, the etching rate and the polishing rate is also approximated between the separation region 14 and the magnetic layer 4. As a result, the surface condition obtained after the etching and/or polishing is accordingly approximated between the separation region 14 and the magnetic layer 4. For this reason, it is possible to readily remove the separation region 14 and the magnetic layer 4 at the same time when the etching and/or polishing is performed. It is possible to obtain a continuous and smooth plane on the top surfaces of the separation region 14 and the magnetic layer 4. It is possible to readily obtain the recording layer 6 having an excellent surface smoothness.

(C) Since the separation region 14 and the magnetic layer 4 can have similar material composition, a potential is also approximated between both areas, and mutual diffusion of structural elements hardly occurs between the separation region 14 and the magnetic layer 4. Therefore, even in the case where the perpendicular magnetic recording medium A according to the present embodiment is provided in the magnetic recording/reproduction apparatus and stored at a high temperature for a long time, characteristics such as an SNR characteristic and a magnetic coercive force are hardly changed, a stable electromagnetic conversion characteristic is obtained for a long time. In addition, in the perpendicular magnetic recording medium A according to the present embodiment, mutual diffusion of elements hardly occurs between the separation region 14 and the magnetic layer 4, and the write fringe caused by the magnetic head is small when the perpendicular magnetic recording medium A is provided in the magnetic recording/reproduction apparatus.

(D) Since the separation region 14 and the magnetic layer 4 can have similar material composition, it is also possible to approximate the hardness and density between the separation region 14 and the magnetic layer 4. As a result, it is possible to make the hardness and density of the entire surface nearly uniform and to improve the surface impact resistance of the recording layer 6 including the separation region 14 and the magnetic layer 4 so that excellent impact resistance is obtained against the impact caused by the magnetic head or the like.

In addition, in the perpendicular magnetic recording medium A according to the present embodiment, the magnetic layer 4 is arranged on the uppermost layer of the recording portion 15, and the protection film 16 is provided to cover the recording portion 15 and the separation region 14. The hardness and the density are approximated between the separation region 14 and the recording portion 15 that supports the protection film 16 as an under layer of the protection film 16. Therefore, the protection film 16 can absorb an impact uniformly on the entire surface when the magnetic head or the like accidentally makes contact, and the protection film is highly resistant to damage and has excellent impact resistance. Therefore, the perpendicular magnetic recording medium A has excellent impact resistance.

Using the method of manufacturing the perpendicular magnetic recording medium A according to the present embodiment, it is possible to manufacture a perpendicular magnetic recording medium A according to the present invention. After the smoothening process, it is possible to form a continuous smooth surface on the separation region 14 and the magnetic layer 4. In addition, according to the present embodiment, a pattern shape including the recording portion 15 and the separation region 14 can be readily formed with high precision.

Magnetic Recording/Reproduction Apparatus

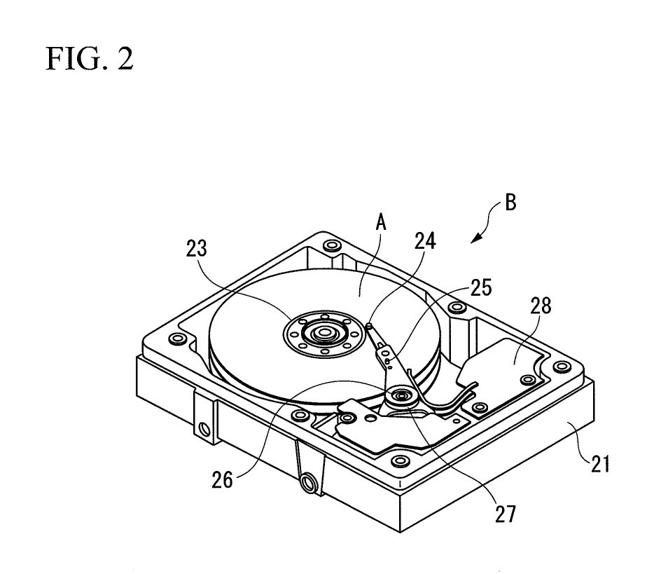

Next, as an example of the magnetic recording/reproduction apparatus according to the present invention, a magnetic recording/reproduction apparatus having the perpendicular magnetic recording medium A shown in FIG. 1I will be described with reference to FIG. 2.

FIG. 2 is a perspective view illustrating a hard disc apparatus as an example of the magnetic recording/reproduction apparatus according to the present invention. The magnetic recording/reproduction apparatus B shown in FIG. 2 includes a casing 21 having a rectangular box shape having an opened upper face and a top cover (not shown) for covering the opening of the casing 21. The casing 21 stores the perpendicular magnetic recording medium A shown in FIG. 1I, a spindle motor 23, a magnetic head 24 (a single magnetic pole head), a head actuator 25, a voice coil motor 27, and a head amplification circuit 28.

The spindle motor 23 is a driving means for supporting and rotating the perpendicular magnetic recording medium A.

The magnetic head 24 includes a recording portion and a reproducing portion to record and reproduce magnetic signals to/from the perpendicular magnetic recording medium A. The magnetic head 24 may be selected as necessary, and, for example, a GMR head or a TMR head may be used. When the GMR head or the TMR head is used as the magnetic head 24, it is possible to obtain a sufficient signal strength even in a high recording density and realize a magnetic recording/reproduction apparatus B having a high recording density. In addition, the levitation amount of the magnetic head 24 may be selected as necessary, and may be set to, for example, 0.005 to 0.020 μm so that output power can be improved, and a high device S/N ratio can be obtained. As a result, it is possible to obtain a magnetic recording/reproduction apparatus B having a high capacity and high reliability.

The head actuator 25 supports the magnetic head 24 movably with respect to the magnetic recording medium 22. The head actuator 25 has a suspension having a magnetic head 24 in the leading end and is movably supported by the rotation shaft 26.

In addition, a voice coil motor 27 positions and rotates the head actuator 25 through a rotation shaft 26.

In addition, in the magnetic recording/reproduction apparatus B, it is possible to further improve the recording density by combining a signal processing unit using a maximum likelihood decoding method. For example, even in the case where the track density is equal to or higher then 100 kTPI, the line recording density is equal to or higher than 1000 kbpI, and the unit area recording density is equal to or higher than 100 Gbit/inch², it is possible to obtain a sufficient S/N ratio.

The magnetic recording/reproduction apparatus B shown in FIG. 2 includes the perpendicular magnetic recording medium A shown in FIG. 1I. Therefore, it is possible to realize a high recording density, obtain a stable electromagnetic conversion characteristic for a long time without write fringe caused by the magnetic head 24, and provide excellent impact resistance against an impact caused by the magnetic head 24 or the like.

### Examples

The perpendicular magnetic recording medium A shown in FIG. 1I was manufactured using the following manufacturing method.

First, a disc-shaped HD glass substrate (manufactured by OHARA Inc., having an outer diameter of 0.85 inches) that was cleaned was prepared as a nonmagnetic substrate 1 and disposed within a vacuum chamber that was evacuated in vacuum equal to or lower than 1.0×10⁻⁵ Pa in advance. On the nonmagnetic substrate 1, a soft under layer 2 was formed by depositing 65Fe-25Co-10B (atom %) of 50 nm without heating, Ru of 0.8 nm, and 65Fe-25Co-10B (atom %) of 50 nm in this order. Subsequently, an orientation control layer 3 made of Ru and having a thickness of 20 nm was formed on the soft under layer 2. A recording layer 6 was formed by further forming a magnetic layer 4 made of 65Co-10Cr-15Pt-10SiO₂ (atom %) and having a thickness of 12 nm on the orientation control layer 3 The magnetic layer 4 has a granular structure obtained by dispersing magnetic material particles, which consists of Co, Cr, and Pt, into SiO₂.

Next, the nonmagnetic substrate 1, where the recording layer 6 was formed, was withdrawn from the vacuum chamber, and a mask layer 5 formed of carbon and having a thickness of 4 nm was formed on the recording layer 6. Then, the resist was coated on the recording layer 6, where the mask layer 5 was formed, using a spin coat. Then, a resist layer was obtained by baking the nonmagnetic substrate 1, where the resist was coated, within a thermostatic chamber at a temperature of 100° C. for twenty minutes to remove remaining solvent.

Next, using a stamper which is made of Ni and has a concave portion in a concentric shape with a track pitch of 150 nm, a desired unevenness portion was formed on the substrate 1 by removing the resist layer located in the area corresponding to the separation region 14. Then, the nonmagnetic substrate 1, where a resist layer having the unevenness portion was formed, is disposed within a high vacuum chamber, and a concentric-shaped recess 11b was formed by removing the recording layer 6 and the mask layer 5 corresponding to the area where the resist layer was not provided (the area corresponding to the separation region 14) using an ion beam etching method. Then, the resist layer 7 and the mask layer 5 remaining on the recording portion 15 were removed.

Then, a nonmagnetic layer having an average thickness of 80 nm, wherein nonmagnetic material particles containing Co, Cr and Pt were dispersed in SiO₂, was formed such that an 40Co-35Cr-15Pt-10SiO₂ (atom %) film as a magnetic material having a granular structure is deposited on the recording layer 6, where the recess l lb was formed using an RF (high frequency) sputtering method. While the nonmagnetic material is composed of the same elements as those of the magnetic material, it has a smaller amount of Co so as to provide a nonmagnetic property. As a result, the separation region 14 was formed such that the recess 11b is filled with the nonmagnetic material having a granular structure. The granular structure can be recognized by taking a SEM photograph and a TEM photograph.

Subsequently, the magnetic layer 4 was exposed using ion beam etching by smoothening the surface of the formed nonmagnetic layer and removing the surfaces of the nonmagnetic layer and magnetic layer 4 in the thickness of approximately 1 nm.

Then, the protection film 16 made of a DLC film having a thickness of 4 nm was formed on the recording layer 6 using a plasma CVD method, and the lubricant layer 17 was formed by coating a lubricant having a thickness of 2 nm on the protection film 16 so that the perpendicular magnetic recording medium A shown in FIG. 1I was obtained.

### Comparison Examples 1 to 4

A perpendicular magnetic recording medium similar to that of the aforementioned example was manufactured except that SiO₂, Si, Cr, or Cr₂O₃ was used as a material of the separation region 14 as shown in Table 1.

In comparison examples 1 to 4, particles filled in the separation region do not have a granular structure.

TABLE 1

| | | | | | | Impact |
|---|---|---|---|---|---|---|
| | Material of guide | Before inserting to oven | | After inserting to oven | | resistance test |
| | band portion | Hc(Oe) | SNR (dB) | Hc(Oe) | SNR (dB) | (number of defects) |
| Example | 40Co—35Cr—15Pt—10SiO₂ | 5100 | 26.1 | 5050 | 25.9 | NO DEFECT |
| | (atom %) | | | | | |
| Comparison 1 | SiO₂ | 5050 | 26.2 | 4900 | 25.5 | 10/plane |
| Comparison 2 | Si | 5060 | 26.1 | 4700 | 24.5 | 50/plane |
| Comparison 3 | Cr | 5150 | 26.3 | 4650 | 24.3 | 84/plane |
| Comparison 4 | Cr₂O₃ | 5140 | 26.2 | 4750 | 24.2 | 96/plane |

The following evaluation was performed for the perpendicular magnetic recording media of the example and the comparison examples 1 to 4 obtained as described above.

Evaluation on Temporal Change of Electromagnetic Conversion Characteristic

The perpendicular magnetic recording media of the example and comparison examples 1 to 4 were put into an oven of a temperature of 80° C. and a humidity of 80% and stored for 720 hours. The signal-to-noise ratio (SNR) and the magnetic coercive force (Hc) were measured for the perpendicular magnetic recording media of the Example and Comparison Examples 1 to 4 before and after being put into the oven. The results are shown in Table 1.

In addition, the evaluation of the SNR was performed using a read/write analyzer (model No. RWA1632) manufactured by GUZIK Technical Enterprises Inc., and a spin stand (model No. S1701MP) based on an rms (root means square-inches) value obtained when signals of 160 kFCI and 960 kFCI are written by using a shielded-type head in a write unit and a magnetic head having a GMR element in a reproduction unit.

Referring to Table 1, it is recognized that, in Example in which the separation region 14 is composed of a nonmagnetic material having a granular structure, mutual diffusion between the recording portion 15 and the separation region 14 is prevented, and thus, there is no temporal change in the SNR and the magnetic coercive force. Meanwhile, in Comparison examples 1 to 4, it is recognized as unpreferable that both the SNR and the magnetic coercive force is significantly degraded by a temporal change in comparison with Example.

Evaluation of Impact Resistance on Surface of Perpendicular Magnetic Recording Medium

Damage on the surface of the perpendicular magnetic recording medium was compared by rotating the perpendicular magnetic recording media of Example and Comparison Examples 1 to 4 at a velocity of 5600 rpm and making contact with the magnetic head a thousand times at a constant radius of the surface thereof for every 0.5 seconds.

The damage was evaluated by observing the surface of the perpendicular magnetic recording medium using a Normarski differential interference contrast microscope at a magnification of 1:300 and counting the number of defects. The result is shown in Table 1.

Referring to Table 1, it is recognized that the perpendicular magnetic recording medium of Example has no defects, and the impact resistance of the surface is excellent. On the contrary, in the perpendicular magnetic recording medium of Comparison Examples 1 to 4, it is recognized that defects are observed, and the impact resistance is low in comparison with the example.

Through the aforementioned evaluation of the impact resistance (scratch evaluation), the smoothness is also indirectly evaluated. According to the present invention, since the smoothness is excellent, there is no damage caused by contact, and there is no defect. Meanwhile, in the comparison examples, since the smoothness is degraded, damage caused by contact is large, and the number of defects is also large.

### INDUSTRIAL APPLICABILITY

It is possible to provide a perpendicular magnetic recording medium that has excellent smoothness on the surface of the separation region, is capable of realizing a high recording density, has no write fringe caused by the magnetic head in the case where it is provided in the magnetic recording/reproduction apparatus, is capable of obtaining a stable electromagnetic conversion characteristic for a long time, and has excellent impact resistance against an impact of the magnetic head or the like.

1. A perpendicular magnetic recording medium comprising:
a nonmagnetic substrate; and
a recording layer formed on the nonmagnetic substrate, the recording layer having magnetic anisotropy in a direction perpendicular to a surface of the nonmagnetic substrate and including a plurality of recording portions and a plurality of separation regions for isolating the neighboring recording portions,
wherein the separation regions are formed of a material having a granular structure.

2. The perpendicular magnetic recording medium according to claim 1, wherein the material having a granular structure is a nonmagnetic material.

3. The perpendicular magnetic recording medium according to claim 1, wherein the recording portion is a layered structure and includes a magnetic layer made of a magnetic material having a granular structure.

4. The perpendicular magnetic recording medium according to claim 3, wherein the magnetic layer and the separation region contain the same oxide.

5. The perpendicular magnetic recording medium according to claim 3, wherein the magnetic layer and the separation region contain Cr.

6. The perpendicular magnetic recording medium according to claim 3, wherein the magnetic layer and the separation region contain an oxide within a range of 5 to 40 volume %.

7. The perpendicular magnetic recording medium according to claim 3, wherein the magnetic layer and the separation region contain at least one selected from a group consisting of SiO₂, SiO, Cr₂O₃, CoO, Ta₂O₃, and TiO₂.

8. The perpendicular magnetic recording medium according to claim 3, wherein the magnetic layer is arranged as an uppermost layer of the recording portion, and
a protection film for covering the recording portion and the separation region is formed on the recording layer.

9. A method of manufacturing a perpendicular magnetic recording medium including a nonmagnetic substrate and a recording layer formed on the nonmagnetic substrate, the recording layer having magnetic anisotropy in a direction perpendicular to a surface of the nonmagnetic substrate and including a plurality of recording portions and a plurality of separation regions for isolating the neighboring recording portions, the method comprising:
forming, on the nonmagnetic substrate, a recording layer having magnetic anisotropy in a direction perpendicular to a surface of the nonmagnetic substrate;
forming a plurality of recording portions and a plurality of recesses for isolating the neighboring recording portions by removing an area corresponding to the separation regions from the recording layer to form the recesses; and
filling the recess with a material having a granular structure to form the separation region.

10. The method of manufacturing a perpendicular magnetic recording medium according to claim 9, wherein the material having the granular structure filled in the recesses is a nonmagnetic material.

11. The method of manufacturing a perpendicular magnetic recording medium according to claim 9, wherein the recording portion includes a magnetic layer formed of a magnetic material having a granular structure.

12. The method of manufacturing a perpendicular magnetic recording medium according to claim 11, wherein the process of filling the recess includes:
depositing a material having the granular structure on the recording layer having the recess to form the nonmagnetic layer having the recess filled with the material, and
smoothening a surface of the nonmagnetic layer by removing a part of the surface of the nonmagnetic layer until the surface of the magnetic layer is exposed and a part of the surface of the magnetic layer is removed.

13. The method of manufacturing a perpendicular magnetic recording medium according to claim 12, further comprising: forming, on the recording layer, a protection film for covering the recording portion and the separation region.

14. The method of manufacturing a perpendicular magnetic recording medium according to claim 11, wherein the process of forming the recess includes: coating a resist on the recording layer to form a resist layer, removing an area of the resist layer corresponding to the separation region using a stamper, and removing an area of the recording layer where the resist layer is removed.

15. The method of manufacturing a perpendicular magnetic recording medium according to claim 11, wherein, in the process of filling the recess, the recess is filled with a material having a granular structure using a sputtering method.

16. The method of manufacturing a perpendicular magnetic recording medium according to claim 12, wherein, in the process of smoothening, a surface of the nonmagnetic layer is smoothened using an ion beam etching method.

17. A magnetic recording/reproduction apparatus including a magnetic recording medium and a magnetic head for recording information on and reproducing information from the magnetic recording medium,
wherein the magnetic recording medium is the perpendicular magnetic recording medium according to claim 1.
